(19) United States
(12) Patent Application Publication
(10) Pub. No.: US 2025/0218441 A1
(43) Pub. Date: Jul. 3, 2025

(54) METHOD AND PROCESSING CIRCUIT FOR PERFORMING WAKE-UP CONTROL ON VOICE-CONTROLLED DEVICE WITH AID OF DETECTING VOICE FEATURE OF SELF-DEFINED WORD

(71) Applicant: Realtek Semiconductor Corp., HsinChu (TW)

(72) Inventor: Ying-Ying Chao, HsinChu (TW)

(73) Assignee: Realtek Semiconductor Corp., HsinChu (TW)

(21) Appl. No.: 18/908,826

(22) Filed: Oct. 8, 2024

(30) Foreign Application Priority Data
Dec. 27, 2023 (TW) 112151041

(51) Int. Cl. G10L 17/02; G10L 17/04; G10L 17/06

(52) U.S. Cl. CPC G10L 17/02; G10L 17/04; G10L 17/06

(57) ABSTRACT

A method for performing wake-up control on a voice-controlled device with aid of detecting voice feature of self-defined word and an associated processing circuit are provided. The method may include: performing feature collection on audio data of at least one audio clip to generate at least one feature list of the at least one audio clip, in order to establish a feature-list-based database in the voice-controlled device; performing the feature collection on audio data of another audio clip to generate another feature list of the other audio clip; and performing at least one screening operation on at least one feature in the other feature list according to the feature-list-based database to determine whether the other audio clip is invalid, in order to selectively ignore the other audio clip or execute at least one subsequent operation, where the at least one subsequent operation includes waking up the voice-controlled device.

### BACKGROUND OF THE INVENTION

### 1. Field of the Invention

The present invention is related to voice control technology, and more particularly, to a method for performing wake-up control on a voice-controlled device with the aid of detecting the voice feature of self-defined word and an associated processing circuit.

### 2. Description of the Prior Art

According to related art, identification systems regarding biometric features may be used for activating user devices to improve convenience and security, but typically need to rely on a remote system with powerful computing capabilities. For example, in order to accurately identify speakers, various conditions involved with the design of an artificial intelligence speaker identification system may vary with respect to language characteristics, speaking habits, gender and age, vocal structure, etc., and therefore establishing a speaker model needs a large amount of appropriate speech data for training the artificial intelligence speaker identification system to successfully perform automatic identification. As it is usually necessary to link to the remote system such as the artificial intelligence speaker identification system through a wired or wireless network, the availability thereof will be affected by network interruptions. Therefore, a novel method and associated architecture are needed to achieve activation control that does not need to rely on any remote system with powerful computing capabilities without introducing any side effect or in a way that is less likely to introduce a side effect.

### SUMMARY OF THE INVENTION

It is an objective of the present invention to provide a method for performing wake-up control on a voice-controlled device with the aid of detecting the voice feature of self-defined word and an associated processing circuit, in order to solve the above-mentioned problems and prevent thieves or young children from accidentally activating the voice-controlled device.

At least one embodiment of the present invention provides a method for performing wake-up control on a voice-controlled device with the aid of detecting the voice feature of self-defined word, where the method may comprise: during a registration phase among multiple phases, performing feature collection on audio data of at least one audio clip to generate at least one feature list of the at least one audio clip, in order to establish a feature-list-based database in the voice-controlled device, wherein the at least one audio clip carries at least one self-defined word, the feature-list-based database comprises the at least one feature list, any feature list among the at least one feature list comprises multiple features of a corresponding audio clip among the at least one audio clip, and the multiple features respectively belong to multiple predetermined types of features; during an identification phase among the multiple phases, performing the feature collection on audio data of another audio clip to generate another feature list of the other audio clip; and during the identification phase, performing at least one screening operation on at least one feature in the other feature list according to the feature-list-based database to determine whether the other audio clip is invalid, in order to selectively ignore the other audio clip or execute at least one subsequent operation, wherein the at least one subsequent operation comprises waking up the voice-controlled device.

At least one embodiment of the present invention provides a processing circuit for performing wake-up control on a voice-controlled device with the aid of detecting the voice feature of self-defined word.

It is an advantage of the present invention that, the method and the processing circuit of the present invention can determine whether an unknown speaker is invalid according to the feature-list-based database, in order to selectively ignore the audio clip thereof or wake up/activate the voice-controlled device, having no need to link to any remote system to obtain any speech data for performing the associated determination/judgment. For example, the method does not need to determine which word(s) are included in the self-defined word, so there is no need to link to any cloud database through any network to obtain a large amount of speech data. In addition, the method and the processing circuit of the present invention can realize a compact, fast, secure and reliable voice control processing system without introducing any side effect or in a way that is less likely to introduce a side effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a voice-controlled device according to an embodiment of the present invention.

FIG. 2 illustrates a working flow of a registration and identification control solution of a method for performing wake-up control on a voice-controlled device with the aid of detecting the voice feature of self-defined word according to an embodiment of the present invention.

FIG. 3 illustrates the audio and the associated signals involved with a feature collection control scheme of the method according to an embodiment of the present invention.

FIG. 4 illustrates an audio pre-processing operation involved with the threshold initialization processing in the feature collection control scheme according to an embodiment of the present invention.

FIG. 5 illustrates audio samples and audio frames involved with the threshold initialization process in the feature collection control scheme according to an embodiment of the present invention.

FIG. 6 illustrates audio analysis operations in the feature collection control scheme according to an embodiment of the present invention.

FIG. 7 illustrates audio frames and audio segments involved with voice type classification in the feature collection control scheme according to an embodiment of the present invention.

FIG. 8 illustrates a working flow of a speaker identification control scheme of the method according to an embodiment of the present invention.

FIG. 9 illustrates data points involved with the k-nearest neighbors (k-NN) algorithm classifier in the speaker identification control scheme according to an embodiment of the present invention.

FIG. 10 illustrates a flowchart of the method according to an embodiment of the present invention.

### DETAILED DESCRIPTION

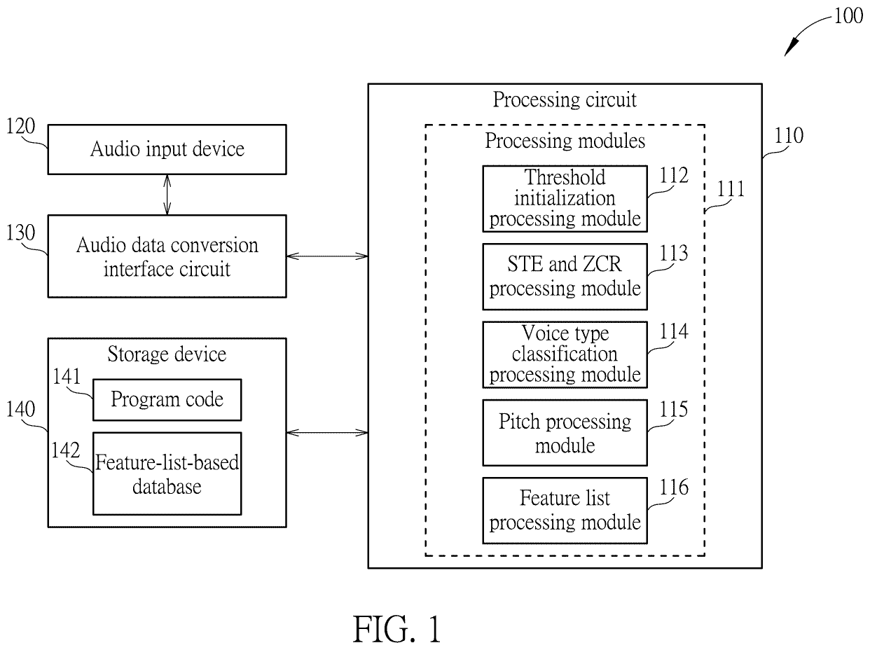

FIG. 1 is a diagram of a voice-controlled device 100 according to an embodiment of the present invention. The voice-controlled device 100 may comprise a processing circuit 110 (e.g., a voice control processing circuit), an audio input device 120, an audio data conversion interface circuit 130 and at least one storage device 140, where the processing circuit 110 may comprise multiple processing modules 111 for performing the operations of the processing circuit 110. The multiple processing modules 111 may comprise a threshold initialization processing module 112, a short-term energy (STE) and zero-crossing rate (ZCR) processing module 113, a voice type classification processing module 114, a pitch processing module 115 and a feature list processing module 116. The feature list processing module 116 may perform feature-list-related processing, and at least one other processing module such as the threshold initialization processing module 112, the short-term energy and zero-crossing rate processing module 113, the voice type classification processing module 114 and the pitch processing module 115 may be arranged to perform feature collection.

For example, the processing circuit 110 may be implemented by way of a processor, a microprocessor, etc., the audio input device 120 may be implemented by way of a microphone, a headset, etc., the audio data conversion interface circuit 130 may be implemented by way of an amplifier, an analog-to-digital converter, etc., and the storage device 140 may be implemented by way of an electrically erasable programmable read-only memory (EEPROM), a flash memory, etc. Examples of the voice-controlled device 100 may include, but are not limited to: voice-controlled locks such as door locks, car locks, etc., and voice-controlled toys. The multiple processing modules 111 may represent multiple program modules running on the processing circuit 110, where the voice-controlled device 100 may load the program code 141 onto the processing circuit 110 to be the multiple program modules. In some embodiments, the multiple processing modules 111 may represent multiple sub-circuits of the processing circuit 110.

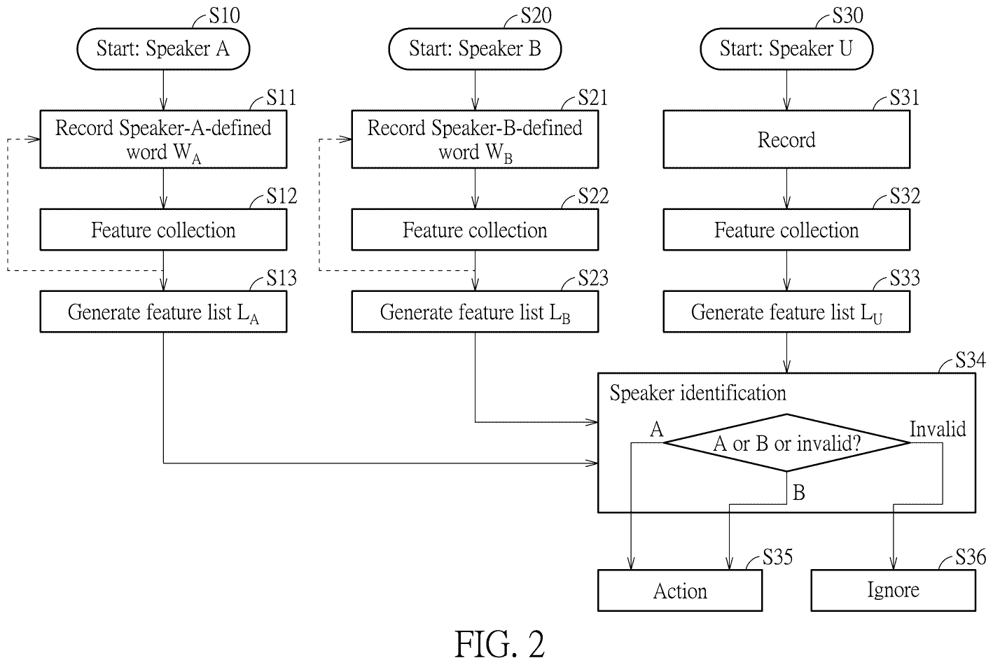

FIG. 2 illustrates a working flow of a registration and identification control solution of a method for performing wake-up control on a voice-controlled device (e.g., the voice-controlled device 100) with the aid of detecting the voice feature of self-defined word according to an embodiment of the present invention. The processing circuit 110 may execute a registration procedure for speakers A and B respectively in a registration phase among multiple phases, and may execute an identification procedure for a speaker U (e.g., an unknown speaker) in an identification phase among the multiple phases, where the registration procedure for the speaker A may comprise Steps S10 to S13, the registration procedure for the speaker B may comprise Steps S20 to S23, and the identification procedure for the speaker U may comprise Steps S30 to S34 and Steps S35 or S36. In the registration phase, the processing circuit 110 may record multiple audio clips {Audio_Clip} (e.g., the audio clips {Audio_Clip_{A}} of the speaker A and the audio clips {Audio_Clip_{B}} of the speaker B), and perform the feature collection on the respective audio data {Audio_Data} of the audio clips {Audio_Clip} (e.g., the respective audio data {Audio_Data_{A}} of the audio clips {Audio_Clip_{A}} and the respective audio data {Audio_Data_{B}} of the audio clips {Audio_Clip_{B}}) to generate the respective feature lists {L} of the audio clips {Audio_Clip} (e.g., the respective feature lists {L_{A}} of the audio clips {Audio_Clip_{A}} and the respective feature lists {L_{B}} of the audio clips {Audio_Clip_{B}}), in order to establish a feature-list-based database 142 in the voice-controlled device 100, where the feature-list-based database 142 may comprise the feature lists {L}, and any feature list L among the feature lists {L} may comprise multiple features of a corresponding audio clip Audio_Clip among the audio clips {Audio_Clip}, and the multiple features respectively belong to multiple predetermined types of features. For example, the audio clips {Audio_Clip} may carry at least one self-defined word W. More particularly, each audio clip Audio_Clip_{A} among the audio clips {Audio_Clip_{A}} may carry a self-defined word W_{A}, and each audio clip Audio_Clip_{B} among audio clips {Audio_Clip_{B}} may carry a self-defined word WB. In addition, in the identification phase, the processing circuit 110 may record another audio clip Audio_Clip (e.g., the audio clip Audio_Clip_{U} of the speaker U), and perform the feature collection on the audio data Audio_Data of the other audio clip Audio_Clip (e.g., the audio data Audio_Data_{U} of the audio clip Audio_Clip_{U}) to generate another feature list L of the other audio clip Audio_Clip (e.g., the feature list L_{U} of the audio clip Audio_Clip_{U}), and perform at least one screening operation on at least one feature in the other feature list L according to the feature-list-based database 142 to determine whether the other audio clip Audio_Clip is invalid, in order to selectively ignore the other audio clip Audio_Clip or perform at least one subsequent operation, having no need to link to any cloud database through any network to obtain any speech data for determining which words are included in the aforementioned at least one self-defined word, where the aforementioned at least one subsequent operation may comprise waking up/activating the voice-controlled device 100.

In Step S10, the processing circuit 110 may start executing the registration procedure for the speaker A.

In Step S11, the processing circuit 110 may record a corresponding audio clip Audio_Clip_{A} among the audio clips {Audio_Clip_{A}} to record the self-defined word W_{A}, such as Speaker-A-defined word W_{A}, to be the Speaker-A-dedicated wake-up word dedicated to speaker A.

In Step S12, the processing circuit 110 may perform the feature collection on the corresponding audio data Audio_Data of the corresponding audio clip Audio_Clip_{A} to obtain multiple features of the corresponding audio clip Audio_Clip_{A}. The processing circuit 110 may re-enter Step S11 as shown by the arrow depicted with the dashed line to repeatedly execute Steps S11 and S12 to perform the feature collection on the audio data {Audio_Data_{A}} of the audio clips {Audio_Clip_{A}}, respectively, in order to obtain the respective features of the audio clips {Audio_Clip_{A}}. For example, the processing circuit 110 may provide user interface(s) such as a record button and a stop button, and the speaker A may press the record button and record the self-defined word W_{A} with the same tone and volume, and then press the stop button. The processing circuit 110 may detect certain voice features of the corresponding audio clip Audio_Clip_{A}. If these voice features comply with the predetermined recording rules, the processing circuit 110 may record the multiple features of the corresponding audio clip Audio_Clip_{A}; otherwise, the processing circuit 110 may notify the speaker A to record again.

In Step S13, the processing circuit 110 may generate the feature list L_{A} according to the multiple features of the corresponding audio clip Audio_Clip_{A}, and more particularly, generate the respective feature lists {L_{A}} of the audio clips {Audio_Clip_{A}} according to the respective features of the audio clips {Audio_Clip_{A}}.

In Step S20, the processing circuit 110 may start executing the registration procedure for the speaker B.

In Step S21, the processing circuit 110 may record a corresponding audio clip Audio_Clip_{B} among the audio clips {Audio_Clip_{B}} to record the self-defined word WB, such as Speaker-B-defined word W_{B}, to be the Speaker-B-dedicated wake-up word dedicated to speaker B.

In Step S22, the processing circuit 110 may perform the feature collection on the corresponding audio data Audio_Data_{B} of the corresponding audio clip Audio_Clip_{B} to obtain multiple features of the corresponding audio clip Audio_Clip_{B}. The processing circuit 110 may re-enter Step S21 as shown by the arrow depicted with the dashed line to repeatedly execute Steps S21 and S22 to perform the feature collection on the audio data {Audio_Data_{B}} of the audio clips {Audio_Clip_{B}}, respectively, in order to obtain the respective features of the audio clips {Audio_Clip_{B}}. For example, the speaker B may press the record button and record the self-defined word W_{B} with the same tone and volume, and then press the stop button. The processing circuit 110 may detect certain voice features of the corresponding audio clip Audio_Clip_{B}. If these voice features comply with the above-mentioned predetermined recording rules, the processing circuit 110 may record the multiple features of the corresponding audio clip Audio_Clip_{B}; otherwise, the processing circuit 110 may notify the speaker B to record again.

In Step S23, the processing circuit 110 may generate the feature list L_{B} according to the multiple features of the corresponding audio clip Audio_Clip_{B}, and more particularly, generate the respective feature lists {L_{B}} of the audio clips {Audio_Clip_{B}} according to the respective features of the audio clips {Audio_Clip_{B}}.

In Step S30, the processing circuit 110 may start executing the identification procedure for the speaker U.

In Step S31, the processing circuit 110 may record the audio clip Audio_Clip_{U} to record any self-defined word W_{U} of the speaker U (if the self-defined word W_{U} exists).

In Step S32, the processing circuit 110 may perform the feature collection on the audio data Audio_Data_{U} of the audio clip Audio_Clip_{U} to obtain multiple features of the audio clip Audio_Clip_{U}.

In Step S33, the processing circuit 110 may generate the feature list L_{U} according to the multiple features of the audio clip Audio_Clip_{U}.

In Step S34, the processing circuit 110 may perform speaker identification according to the feature-list-based database 142, and more particularly, quickly perform screening operation(s) on one or more features in the feature list L_{U} according to the feature-list-based database 142 to determine whether the audio clip Audio_Clip_{U} is invalid. For example, when it is determined that the audio clip Audio_Clip_{U} is invalid, which means that the speaker U is an invalid speaker, the processing circuit 110 may execute Step S36. When it is determined that the audio clip Audio_Clip_{U} is not invalid, which means that the speaker U is the speaker A or the speaker B, the processing circuit 110 may execute Step S35.

In Step S35, the processing circuit 110 may perform the above-mentioned at least one subsequent operation as the action Action( ) and more particularly, wake up/activate the voice-controlled device 100.

In Step S36, the processing circuit 110 may ignore the audio clip Audio_Clip_{U}.

As the registered speakers may have different self-defined words {W}, for any registered speaker, as long as the self-defined word W is not heard by others, there is a first layer of security; even if the self-defined word W is heard by others, there is a second layer of security, since the voice-controlled device 100 cannot be awakened/activated when the voice features are different. If the speaker speaks the self-defined word W using different tones or different volumes, the processing circuit 110 will determine that the audio clip Audio_Clip of this speaker is invalid/unqualified, so there is no need to worry about daily conversations being recorded for forging speech to activate the voice-controlled device 100. In addition, the processing circuit 110 can quickly determine whether the speaker U (e.g., the unknown speaker) is invalid according to the feature-list-based database 142, in order to selectively ignore the audio clip Audio_Clip_{U} thereof or wake up/activate the voice-controlled device 100, having no need to link to any remote system to obtain any speech data for the associated determination/judgment. As there is no need to determine which words are included in the self-defined words, the processing circuit 110 does not need to link to any cloud database through any network to obtain a large amount of speech data. Therefore, the method and processing circuit 110 of the present invention can realize a compact, fast, secure and reliable voice-controlled processing system without introducing any side effect or in a way that is less likely to introduce a side effect.

According to some embodiments, one or more steps may be added, deleted, or changed in the working flow shown in FIG. 2. For example, by performing machine learning, the processing circuit 110 may establish a predetermined classifier corresponding to at least one predetermined model in the voice-controlled device 100, where the dimension of a predetermined space (e.g., the predetermined space expanded by multiple axes {X₁, X₂, . . . }) of the aforementioned at least one predetermined model may be equal to the feature-type count of the multiple predetermined types of features. In addition, the above-mentioned at least one feature in the other feature list L may be at least one of all features in the other feature list L, where the above-mentioned all features in the other feature list L respectively belong to the multiple predetermined types of features. During performing the aforementioned at least one subsequent operation, the processing circuit 110 may utilize the predetermined classifier to perform machine-learning-based classification according to the above-mentioned all features in the other feature list L to determine whether the speaker U of the other audio clip Audio_Clip is the speaker A (e.g., the user A) or the speaker B (e.g., the user B), in order to selectively execute at least one action Action(A) corresponding to the speaker A (e.g., the user A) or at least one action Action(B) corresponding to the speaker B (e.g., the user B) in Step S35.

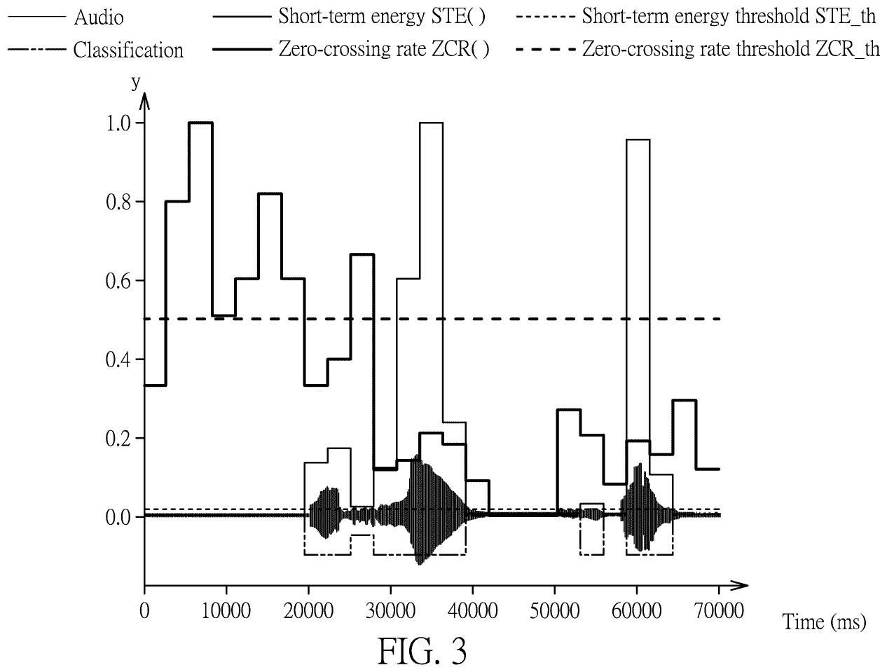

FIG. 3 illustrates the audio and the associated signals involved with a feature collection control scheme of the method according to an embodiment of the present invention, where the horizontal axis may represent time, measured in units of milliseconds (ms), and, for the audio, the vertical axis may represent the intensity of the audio samples y. According to some embodiments, the audio and the associated signals such as the short-term energy STE( ) zero-crossing rate ZCR ( ) and the classification signal may vary. As shown in FIG. 3, the processing circuit 110 may generate the classification signal according to whether the short-term energy STE( ) reaches the short-term energy threshold STE_th and whether the zero-crossing rate ZCR ( ) reaches the zero-crossing rate threshold ZCR_th to indicate any part among multiple parts of the audio is unvoiced, voiced or breathy voice. For example, the processing circuit 110 may detect that the pitch of the audio is equal to 181.07 hertz (Hz).

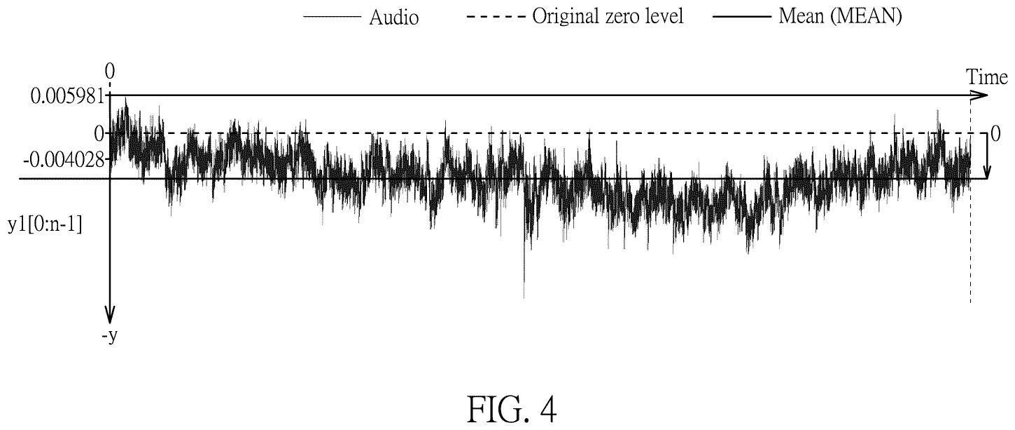

FIG. 4 illustrates an audio pre-processing operation involved with the threshold initialization processing in the feature collection control scheme according to an embodiment of the present invention, where the threshold initialization processing module 112 shown in FIG. 1 may be arranged to perform the threshold initialization processing. The threshold initialization processing module 112 may perform the audio pre-processing operation on the original version (e.g., the audio sample y1) of the audio sample y to generate a new version (e.g., the audio sample y2) of the audio sample y. Assuming that the sampling frequency of the audio sample y1 is equal to 48000 Hz and that the duration t_{NOISE} of the noise part at the beginning of the audio sample y1 is equal to 0.4 seconds(s), the sample count n thereof is equal to (48000*0.4)=19200. According to some embodiments, the associated parameters such as the sampling frequency, the duration t_{NOISE}, etc. may vary. The threshold initialization processing module 112 may calculate the mean MEAN (e.g., arithmetic mean/average) as follows:

$$MEAN = ( SUM ( y 1 [ 0 : n - 1 ] ) / n ) = ( SUM ( y 1 [ 0 : 19199 ] ) / 19200 ) ;$$

where “SUM ( )” may represent the summation. The mean MEAN may indicate the signal offset caused by components (e.g., the audio input device 120 and/or the audio data conversion interface circuit 130) on the audio input path. The threshold initialization processing module 112 may calibrate the original zero level according to the mean MEAN, and more particularly, subtract the mean MEAN from all audio samples y1 that have been recorded to generate the audio samples y2 as follows:

$$y 2 [ 0 : N - 1 ] = y 1 [ 0 : N - 1 ] - MEAN ;$$

where “N” may represent the sample count of the audio samples y1 (or y2).

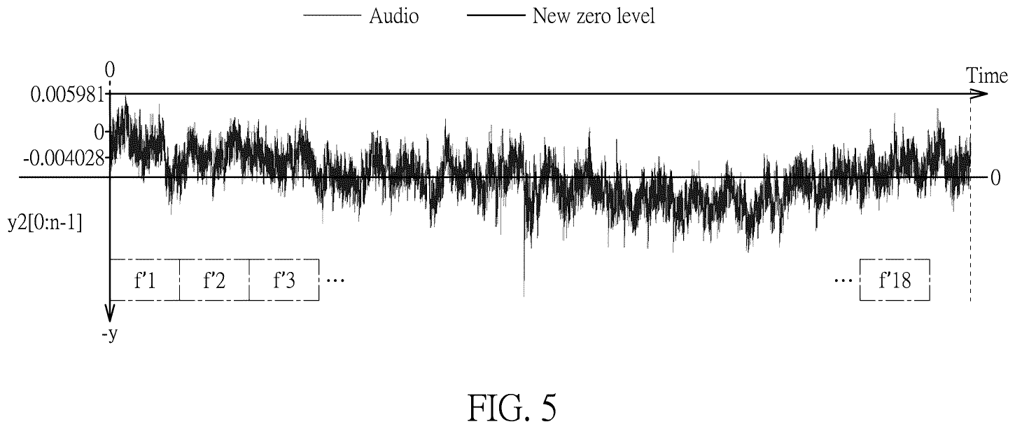

FIG. 5 illustrates the audio samples {y2} (e.g., the audio samples y2 [0: n−1]) and the audio frames {f} (e.g., the audio frames {f1, f2, f′3, . . . , f18}) involved with the threshold initialization process in the feature collection control scheme according to an embodiment of the present invention, where the threshold initialization processing module 112 may subtract the mean MEAN from the original zero level shown in FIG. 4 to obtain a new zero level. Assuming that the frame size p1 of the audio frames {f} (or the noise frames {f}) of the noise part is equal to 1024 audio samples, the frame count in the duration t_{NOISE} of the noise part is equal to (n/p1)=(19200/1024)=18.75˜=18, which means there are at least eighteen frames in the duration t_{NOISE}. According to some embodiments, the associated parameters such as the duration t_{NOISE}, the sample count n, the frame size p1, etc. may vary. Let the frame size p be equal to p1 (i.e., p=p1), and then any audio frame f′ (i) among the audio frames {f} may comprise the audio samples {y2 [(i−1) * p], . . . , y2 [(i*p)−1] | i=1, . . . , 18}. The threshold initialization processing module 112 may calculate the short-term energy value STE(f′ (i)) of the audio frame f′ (i) as follows:

$$STE ( f ’ ( i ) ) = SUM ( \{ y {2 [ x ]}^{2} \vert x = ( ( i - 1 ) * p ) , … , ( ( i * p ) - 1 ) \} ) ;$$

where “y2 [x]²” may represent the energy of the audio sample y2 [x]. The threshold initialization processing module 112 may calculate the short-term energy threshold STE_th according to the respective short-term energy values {STE(f (i))} of the audio frames {f (i)} as follows:

$$STE\_th = MAX ( \{ STE ( f ’ ( i ) ) \} ) * FACTOR\_STE ;$$

where “MAX ( )” may represent the maximum value, and “FACTOR_STE” may represent a predetermined short-term energy factor. For example, FACTOR_STE=10, arranged to determine the short-term energy threshold STE_th for determining whether the speaker is speaking or there is only noise. According to some embodiments, the short-term energy threshold STE_th and/or the predetermined short-term energy factor FACTOR_STE may vary.

In addition, the threshold initialization processing module 112 may calculate the zero-crossing rate threshold ZCR_th. Let y3 [x] be a function of y2 [x] for indicating whether y2 [x] is greater than zero as follows:

$$\begin{matrix}y 3 [ x ] = 1 if y 2 [ x ] > 0 ; and \\ y 3 [ x ] = - 1 , if y 2 [ x ] \leq 0 .\end{matrix}$$

According to some embodiments, y3 [x] and/or the associated determination conditions (e.g., y2 [x]>0 and/or y2 [x]≤0) may vary. The threshold initialization processing module 112 may calculate the zero-crossing rate value ZCR (f″ (i)) of the audio frame f (i) as follows:

$$ZCR ( f ’ ( i ) ) = SUM ( \{ ( \vert y 3 [ x + 1 ] - y 3 [ x ] \vert ) \vert x = ( ( i = 1 ) * p ) , … , ( ( i * p ) - 1 ) \} ) / 2 p ;$$

where “| y3 [x+1]-y3 [x] |” may represent the absolute value of (y3 [x+1]-y3 [x]). According to the above-mentioned predetermined recording rules, the zero-crossing rate of the noise sequence is expected to be large enough, and more particularly, to reach a predetermined noise sequence zero-crossing rate threshold Noise_Sequence_ZCR_th, which may indicate that this noise sequence is a qualified noise for correctly performing the threshold initialization processing. In the registration procedure, the threshold initialization processing module 112 may determine, according to the respective zero-crossing rate values {ZCR (f (i))} of the audio frames {f (i)} and the predetermined noise sequence zero-crossing rate threshold Noise_Sequence_ZCR_th, whether to notify the registering speaker/user (e.g., the speaker/user A or the speaker/user B) to record again, and the associated operations may comprise:
(1) if MIN ({ZCR (f′ (i))})<Noise_Sequence_ZCR_th, the processing circuit 110 (or the threshold initialization processing module 112) may control the voice-controlled device 100 to notify the speaker/user to record again; and
(2) if MIN ({ZCR (f (i))})≥Noise_Sequence_ZCR_th, the threshold initialization processing module 112 may set ZCR_th=MIN ({ZCR (f′ (i))});
where “MIN ( )” may represent the minimum value. For example, the predetermined noise sequence zero-crossing rate threshold Noise_Sequence_ZCR_th may be equal to 0.3. In some examples, the predetermined noise sequence zero-crossing rate threshold Noise_Sequence_ZCR_th may vary.

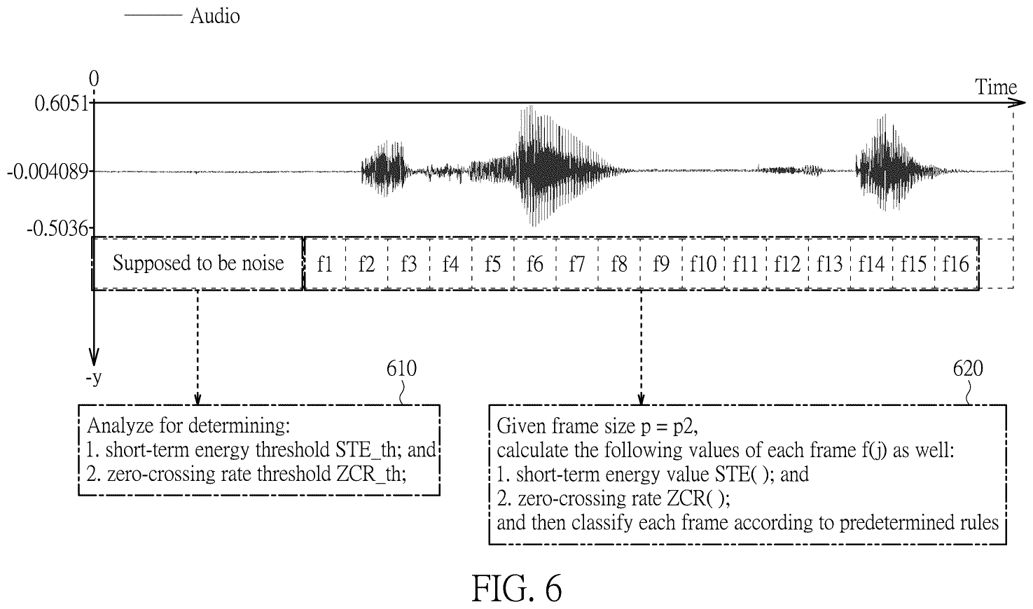

FIG. 6 illustrates audio analysis operations 610 and 620 in the feature collection control scheme according to an embodiment of the present invention, where the threshold initialization processing module 112 and the short-term energy and zero-crossing rate processing module 113 shown in FIG. 1 may be arranged to perform the audio analysis operations 610 and 620, respectively. After recording the corresponding audio clip Audio_Clip (e.g., the corresponding audio clip Audio_Clip_{A} or the corresponding audio clip Audio_Clip_{B}) to obtain the corresponding audio data Audio_Data (e.g., the corresponding audio data Audio_Data_{A} or the corresponding audio data Audio_Data_{B}) of the corresponding audio clip Audio_Clip, the threshold initialization processing module 112 may analyze first audio data Audio_Data1 of a first partial audio clip Audio_Clip1 (e.g., the noise part) of the corresponding audio clip Audio_Clip, to determine the short-term energy threshold STE_th and the zero-crossing rate threshold ZCR_th according to multiple first audio frames (e.g., the audio frames {f}) of the first audio data Audio_Data1, for further processing remaining audio data Audio_Data2 of a remaining partial audio clip Audio_Clip2 of the corresponding audio clip Audio_Clip. As shown in the leftmost part of FIG. 6, the beginning part (e.g., the audio frames {f (i)} such as the audio frames {f1, f′2, f′3, . . . , f′18}}) of the audio may be expected as noise.

In addition, the short-term energy and zero-crossing rate processing module 113 may analyze the remaining audio data Audio_Data2 of the remaining partial audio clip Audio_Clip2 to calculate the respective short-term energy values {STE( )} and zero-crossing rates {ZCR ( )} of multiple second audio frames (e.g., the audio frames {f}) of the remaining audio data Audio_Data2. According to whether the short-term energy value STE( ) of any second audio frame (e.g., the audio frame f) among the multiple second audio frames reaches the short-term energy threshold STE_th and whether the zero-crossing rate ZCR ( ) of the any second audio frame (e.g., the audio frame f) reaches the zero-crossing rate threshold ZCR_th, the processing circuit 110 (or the voice type classification processing module 114) may determine that the voice type of the any second audio frame (e.g., the audio frame f) is one of multiple predetermined voice types (e.g., an unvoiced type, a voiced type and a breathy voice type), for determining the multiple features of the corresponding audio clip Audio_Clip according to the respective voice types of the multiple second audio frames (e.g., the audio frames {f}).

Assuming that the frame size p is equal to p2 (i.e., p=p2), the short-term energy and zero-crossing rate processing module 113 may calculate the short-term energy value STE(f(j)) and the zero-crossing rate ZCR (f(j)) of any audio frame f(j) among the audio frames {f(j)} (e.g., the audio frames {f1, f2, f3, f4, f5, f6, f7, f8, f9, f10, f11, f12, f13, f14, f15, f16}), and based on a set of predetermined classification rules, the processing circuit 110 (or the voice type classification processing module 114) may classify the any audio frame f(j) as one of the multiple predetermined voice types according to the short-term energy value STE(f(j)) and the zero-crossing rate ZCR(f(j)), for example:
(1) if STE(f(j))<STE_th, the processing circuit 110 (or the voice type classification processing module 114) may determine that the voice type of the any audio frame f(j) is the unvoiced type;
(2) if STE(f(j))≥STE_th and ZCR (f(j))<ZCR_th, the processing circuit 110 (or the voice type classification processing module 114) may determine that the voice type of the any audio frame f(j) is the voiced type; and
(3) if STE(f(j))≥STE_th and ZCR (f(j))≥ZCR_th, the processing circuit 110 (or the voice type classification processing module 114) may determine that the voice type of the any audio frame f(j) is the breathy voice type.

According to some embodiments, the set of predetermined classification rules and the associated calculations and/or the associated parameters such as the frame size p, the frame count of the audio frames {f(j)}, etc. may vary.

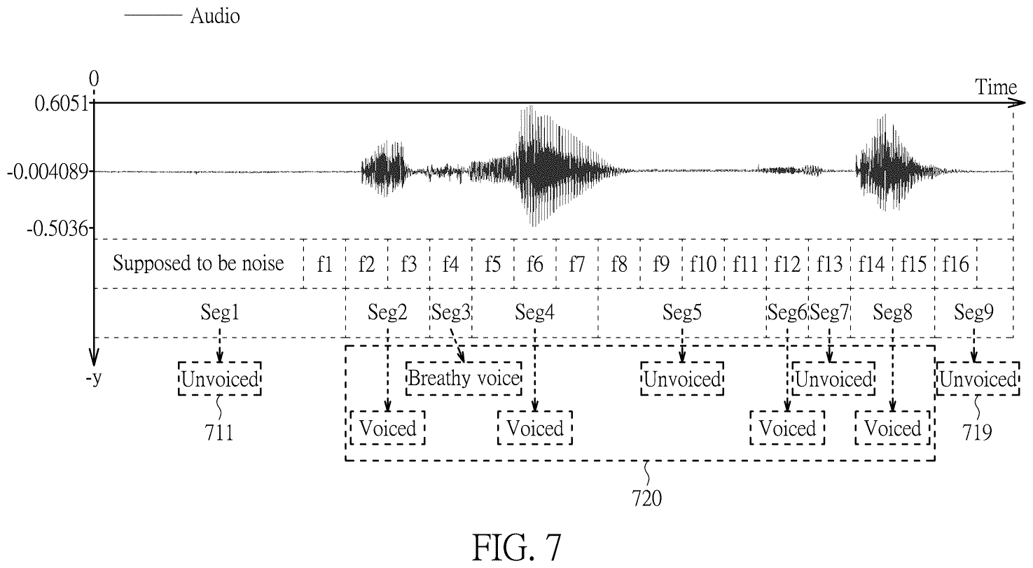

FIG. 7 illustrates the audio frames {f(j)} and the audio segments {Seg(k)} involved with voice type classification in the feature collection control scheme according to an embodiment of the present invention, where the voice type classification processing module 114 shown in FIG. 1 may be arranged to perform the voice type classification. According to the above-mentioned respective voice types of the multiple second audio frames (e.g., the audio frames {f(j)} such as the audio frames {f1, f2, . . . , f16}), the voice type classification processing module 114 may divide the corresponding audio clip Audio Clip into multiple audio segments {Seg(k)} such as the audio segments {Seg1, Seg2, Seg3, Seg4, Seg5, Seg6, Seg7, Seg8, Seg9}. Any two adjacent audio frames having a same predetermined voice type among all audio frames of the corresponding audio data Audio_Data may belong to a same audio segment Seg(k), the above-mentioned all audio frames of the corresponding audio data Audio_Data may comprise the multiple first audio frames (e.g., the audio frames {f′ (i)}) and the multiple second audio frames (e.g., the audio frames {f(j)}), and a beginning audio segment 711 (e.g., the audio segment Seg1) among the multiple audio segments {Seg(k)} may comprise at least the multiple first audio frames and may correspond to a first predetermined voice type such as the unvoiced type.

More particularly, the voice type classification processing module 114 may calculate the total time length of at least one main audio segment 720 (e.g., the audio segments {Seg2, Seg3, . . . , Seg8}) among the multiple audio segments {Seg(k)}, such as the duration Duration( ) to be a feature among the multiple features of the corresponding audio clip Audio_Clip. The aforementioned at least one main audio segment 720 may comprise any audio segment (e.g., one or more audio segments) other than the beginning audio segment 711 and any ending audio segment 719 (e.g., audio segment Seg9) corresponding to the first predetermined voice type (e.g., the unvoiced type) among the multiple audio segments {Seg(k)}, such as the audio segments {Seg2, Seg3, . . . , Seg8}. In addition, the voice type classification processing module 114 may utilize one or more other processing modules in the processing module 111 to calculate at least one segment-level parameter of each audio segment Seg(k) (e.g., each of the audio segments {Seg2, Seg4, Seg6, Seg8}) corresponding to a second predetermined voice type (e.g., the voiced type) among the multiple audio segments {Seg(k)}, in order to determine at least one parameter of the corresponding audio clip Audio_Clip according to the aforementioned at least one segment-level parameter to be at least one other feature among the multiple features of the corresponding audio clip Audio_Clip, where the above-mentioned each audio segment Seg(k) may represent a voiced segment Seg(k). For example, the aforementioned at least one segment-level parameter may comprise the pitch Pitch( ) the short-term energy value STE( ) and the zero-crossing rate ZCR ( ) of the above-mentioned each audio segment Seg(k), and the aforementioned at least one parameter may comprise the pitch Pitch( ) the short-term energy value STE( ) and the zero-crossing rate ZCR ( ) of the corresponding audio clip Audio_Clip. According to some embodiments, the aforementioned at least one segment-level parameter and/or the aforementioned at least one parameter may vary. For example, the aforementioned at least one parameter may further comprise the starting time point Pos( ) of a certain main audio segment among the aforementioned at least one main audio segment 720 of the corresponding audio clip Audio_Clip.

The calculation of the pitch Pitch( ) regarding the above-mentioned each audio segment Seg(k) (e.g., the voiced segment Seg(k), such as each of the audio segments {Seg2, Seg4, Seg6, Seg8}) may be described as follows. The voice type classification processing module 114 may utilize the pitch processing module 115 to calculate the pitch Pitch( ) of the voiced segment Seg(k) according to any predetermined pitch calculation function among one or more predetermined pitch calculation functions. For example, the one or more predetermined pitch calculation functions may comprise a first predetermined pitch calculation function such as an autocorrelation (or auto-correlation) function (ACF) ACF( ) and a second predetermined pitch calculation function such as an average magnitude difference function (AMDF) AMDF ( ) Assuming that the length of the voiced segment Seg(k) is equal to Q (or Q audio samples), the autocorrelation function ACF( ) may be expressed as follows:

$$\begin{matrix}ACF ( m ) = {\sum }_{q = m}^{Q - 1} ( y 2 ( q ) * y 2 ( q - m ) ) ; or \\ ACF ( m ) = {\sum }_{q = m , … , Q - 1} ( y 2 ( q ) * y 2 ( q - m ) ) ;\end{matrix}$$

where “Σ” may represent the summation, and “q” may represent the sample index of the associated audio sample y2(q), and may be an integer in the interval [m, Q−1]. The pitch processing module 115 may find the maximum ACF(m) in the range of M₁<m<M₂-1. For example, M1 may be the number of autocorrelation points to be calculated, corresponding to the minimum pitch period to be searched by the pitch processing module 115, and M2 may be the number of autocorrelation points to be calculated, corresponding to the maximum pitch period to be searched by the pitch processing module 115. In addition, the average magnitude difference function AMDF ( ) may be expressed as follows:

$$\begin{matrix}ACF ( m ) = {\sum }_{q = m}^{Q - 1} ( y 2 ( q ) * y 2 ( q - m ) ) ; or \\ ACF ( m ) = {\sum }_{q = m , … , Q - 1} ( y 2 ( q ) * y 2 ( q - m ) ) .\end{matrix}$$

where “Σ” may represent the summation, and “q” may represent the sample index of the associated audio sample y2(q), and may be an integer in the interval [0, Q−1]. The pitch processing module 115 may find the minimum AMDF (m) in the range of M₁<m<M₂-1.

The voiced segment Seg(k) (whose length is equal to Q) may be regarded as a periodic signal with the period T₀ being equal to m (i.e., T₀=m), and the fundamental frequency f₀ is equal to (1/T₀). For example, when the sampling frequency fs is equal to 48000 Hz, the pitch processing module 115 may calculate the period T₀ and the fundamental frequency f₀ as follows:

$$\begin{matrix}{T}_{0} = m = 250 ( samples ) = ( 250 / 48000 ) ( seconds ) ; and \\ {f}_{0} = ( 1 / {T}_{0} ) = ( fs / m ) = ( 48 \; 000 / 250 ) = 192 ( Hz ) .\end{matrix}$$

According to some embodiments, the one or more predetermined pitch calculation functions and/or the associated parameters may vary. In general, the range of the pitch Pitch( ) may be 60 to 300 Hz, where the range of the pitch Pitch( ) for men may be 60 to 180 Hz, and the range of the pitch Pitch( ) for women may be 160 to 300 Hz. For example, when the sampling frequency fs is equal to 48000 Hz:

$$\begin{matrix}If {f}_{0} = 60 ( Hz ) , then {T}_{0} = ( 48000 / 60 ) = 800 ; and \\ If {f}_{0} = 300 ( Hz ) , then {T}_{0} = ( 48000 / 300 ) = 160 ;\end{matrix}$$

so the pitch period may be 160 to 800 samples. Therefore, the pitch processing module 115 may set M₁₌₁₆₀ and M_{2=800.}

The calculation of the short-term energy value STE( ) and the zero-crossing rate ZCR ( ) regarding the above-mentioned each audio segment Seg(k) (e.g., the voiced segment Seg(k), such as each of the audio segments {Seg2, Seg4, Seg6, Seg8}) may be described as follows. The voice type classification processing module 114 may utilize the short-term energy and zero-crossing rate processing module 113 to calculate the short-term energy value STE(Seg(k)) and the zero-crossing rate ZCR (Seg(k)) of the voiced segment Seg(k) as follows:

$$\begin{matrix}STE ( Seg ( k ) ) = AVG ( \{ STE ( f ( j ) ) \vert j - j 1 ( k ) , … , j 2 ( k ) \} ) ; and \\ ZCR ( Seg ( k ) ) = AVG ( \{ ZCR ( f ( j ) ) \vert j = j 1 ( k ) , … , j 2 ( k ) \} ) ;\end{matrix}$$

where “AVG ( )” may represent the average, “j1 (k)” may represent the index of the beginning audio frame f(j1 (k)) of the voiced segment Seg(k), and “j2 (k)” may represent the index of the ending audio frame f(j2 (k)) of the voiced segment Seg(k).

According to some embodiments, the processing circuit 110 (or the feature list processing module 116) may generate the feature lists {L} such as the feature lists {L_{A}} and {L_{B}} according to a predetermined feature list format. For example, the multiple predetermined types of features may comprise the short-term energy value STE( ) the zero-crossing rate ZCR ( ) the starting time point Pos( ) the pitch Pitch( ) and the duration Duration( ) and the predetermined feature list format may represent the feature list format (STE( ) ZCR ( ) Pos( ) Pitch( ) Duration( )) carrying the short-term energy value STE( ) the zero-crossing rate ZCR ( ) the starting time point Pos( ) the pitch Pitch( ) and the duration Duration( ) In some examples, the multiple predetermined types of features and/or the predetermined feature list format may vary.

TABLE 1

| | STE( ) | ZCR( ) | Pos( ) | Pitch( ) | Duration( ) |
|---|---|---|---|---|---|
| A | 0.0001776469 | 0.057857143 | 2800 | 111.7718733 | 39200 |
| A | 0.0000499814 | 0.021830357 | 25200 | 109.6723773 | 39200 |
| A | 0.0002593765 | 0.052142857 | 2800 | 111.9293174 | 39200 |
| A | 0.0002746699 | 0.039017857 | 25200 | 110.6280869 | 44800 |
| A | 0.0000897361 | 0.059107143 | 5600 | 112.5243115 | 44800 |
| B | 0.0001176279 | 0.044642857 | 2800 | 189.5970772 | 42000 |
| B | 0.0003191778 | 0.036785714 | 44800 | 182.5511925 | 44800 |
| B | 0.0001501330 | 0.034464286 | 44800 | 170.5458264 | 44800 |
| B | 0.0001324947 | 0.036428571 | 2800 | 197.4202607 | 42000 |
| B | 0.0001378857 | 0.033214286 | 44800 | 178.4916067 | 44800 |

TABLE 2

| | STE( ) | ZCR( ) | Pos( ) | Pitch( ) | Duration( ) |
|---|---|---|---|---|---|
| A | 0.0823451200 | 1.45292435 | −0.95713666 | −0.97132086 | −1.3764944 |
| A | −1.4695843500 | −1.75679355 | 0.27787838 | −1.02837763 | −1.3764944 |
| A | 1.0758678400 | 0.94382411 | −0.95713666 | −0.96704209 | −1.3764944 |
| A | 1.2617777200 | −0.2255155 | 0.27787838 | −1.00240487 | 0.91766294 |
| A | −0.9863176100 | 1.56429003 | −0.80275978 | −0.95087229 | 0.91766294 |
| B | −0.6472588500 | 0.27563005 | −0.95713666 | 1.14368901 | −0.22941573 |
| B | 1.8028253900 | −0.42438277 | 1.35851655 | 0.95220714 | 0.91766294 |
| B | −0.2521198100 | −0.63120475 | 1.35851655 | 0.62594435 | 0.91766294 |
| B | −0.4665348100 | −0.45620154 | −0.95713666 | 1.35629507 | −0.22941573 |
| B | −0.4010006400 | −0.74257042 | 1.35851655 | 0.84188216 | 0.91766294 |

Table 1 illustrates examples of the temporary feature lists {L_tmp_{A}} and {L_tmp_{B}} regarding the speakers A and B, and Table 2 illustrates examples of the feature lists {L_{A}} and {L_{B}} regarding the speakers A and B. The processing circuit 110 (or the short-term energy and zero-crossing rate processing module 113) may find out the maximum value among the respective short-term energy values {STE(Seg(k))} of the voiced segments {Seg(k)} (e.g., the audio segments {Seg2, Seg4, Seg6, Seg8}) to be the short-term energy value STE( ) of the corresponding audio clip Audio_Clip. More particularly, the processing circuit 110 (or the feature list processing module 116) may record the short-term energy value STE(Seg(k)), the zero-crossing rate ZCR (Seg(k)), the starting time point Pos(Seg(k)) and the pitch Pitch(Seg(k)) of the voiced segment Seg(k) with the maximum value to be the short-term energy value STE( ) the zero-crossing rate ZCR ( ) the starting time point Pos( ) and the pitch Pitch( ) of the corresponding audio clip Audio_Clip, and record the duration Duration( ) of the audio clip Audio_Clip, to establish a corresponding temporary feature list L_tmp in the temporary feature lists {L_tmp} (e.g., the temporary feature lists {L_tmp_{A}} and {L_tmp_{B}}), and perform normalization on the temporary feature lists {L_tmp} (e.g., the temporary feature lists {L_tmp_{A}} and {L_tmp_{B}}) to generate the feature lists {L} (e.g., the feature lists {L_{A}} and {L_{B}}).

For example, the feature list processing module 116 may perform the above-mentioned feature-list-related processing to generate the temporary feature lists {L_tmp_{A}} and {L_tmp_{B}} such as the temporary feature lists {{(0.0001776469, 0.057857143, 2800, 111.7718733, 39200), (0.0000499814, 0.021830357, 25200, 109.6723773, 39200), . . . , (0.0000897361, 0.059107143, 5600, 112.5243115, 44800)}, {(0.000117627, 0.044642857, 2800, 189.5970772, 42000), (0.0003191778, 0.036785714, 44800, 182.5511925, 44800), . . . , (0.0001378857, 0.033214286, 44800, 178.4916067, 44800)}} shown in Table 1, and convert the temporary feature lists {L_tmp_{A}} and {L_tmp_{B}} into the feature lists {L_{A}} and {L_{B}} such as the feature lists {{(0.0823451200, 1.45292435, −0.95713666, −0.97132086, −1.3764944), (−1.4695843500, −1.75679355, 0.27787838, −1.02837763, −1.3764944), . . . , (−0.9863176100, 1.56429003, −0.80275978, −0.95087229, 0.91766294)}, {(−0.6472588500, 0.27563005, −0.95713666, 1.14368901, −0.22941573), (1.8028253900, −0.42438277, 1.35851655, 0.95220714, 0.91766294), . . . , (−0.4010006400, −0.74257042, 1.35851655, 0.84188216, 0.91766294)}} shown in Table 2, respectively. In other examples, the temporary feature lists {L_tmp_{A}} and {L_tmp_{B}} and the feature lists {L_{A}} and {L_{B}} may vary.

In any table among Table 1 and Table 2, each row may be regarded as a sample, and each column except the column 0 (for indicating the speakers A or B by labeling as “A” or “B”) may be regarded as a feature F(Col). The feature list processing module 116 may perform the above-mentioned normalization on the columns 1 to 5 (e.g., the features {F1(1), F1(2), F1(3), F1(4), F1 (5)}) of Table 1 to generate the columns 1 to 5 (e.g., the features {F2(1), F2(2), F2(3), F2(4), F2 (5)}) of Table 2, where for the converted feature F2 in Table 2, the mean is equal to zero and the standard deviation is equal to one, which may reduce the impact of outliers. For example, the associated operations may comprise:
(1) regarding each feature F1 (Col) of the respective self-defined words W_{A} and W_{B} of the speakers A and B, the feature list processing module 116 may calculate the mean Mean1(Col) and the standard deviation Std1(Col) of all samples in Table 1, where regarding the features {F1(1), F1(2), F1(3), F1(4), F1(5)} (e.g., the short-term energy value STE( ) the zero-crossing rate ZCR ( ) the starting time point Pos( ) the pitch Pitch( ) and the duration Duration( ), the feature list processing module 116 may calculate the means {Mean1 (1), Mean1 (2), Mean1 (3), Mean1 (4), Mean1 (5)} and the standard deviations {Std1(1), Std1(2), Std1(3), Std1(4), Std1(5)} of all samples in Table 1, respectively; and
(2) the feature list processing module 116 may convert the feature F1 (Col) into the feature F2 (Col) so that F2 (Col)=(F1 (Col)−Mean1 (Col))/Std1(Col), and more particularly, convert the features {F1 (1), F1 (2), F1 (3), F1 (4), F1 (5)} in the temporary feature lists {L_tmp} into the features {F2 (1), F2 (2), F2 (3), F2 (4), F2 (5)} in the feature lists {L} respectively;
where “Col” may represent an integer in the interval [1, 5]. The feature list processing module 116 may store the conversion parameters {(Mean1 (1), Std1(1)), (Mean1 (2), Std1(2)), (Mean1 (3), Std1(3)), (Mean1 (4), Std1(4)), (Mean1 (5), Std1(5))} between the features {F2 (1), F2 (2), F2 (3), F2 (4), F2 (5)} and {F1 (1), F1 (2), F1 (3), F1 (4), F1 (5)} in the storage device 140, for converting the temporary feature list L_tmp_{U} of the audio data Audio_Data_{U} of the audio clip Audio_Clip_{U} of the speaker U into the feature list L_{U} of the audio data Audio_Data_{U} in the identification procedure. The feature list processing module 116 may convert the feature F_{U}1(Col) in the temporary feature list L_tmp_{U} into the feature F_{U}2 (Col) in the feature list L_{U} so that F_{U}2 (Col)=(F_{U}1 (Col)−Mean1 (Col))/Std1(Col), and more particularly, convert the features {Fr-1 (1), Fr-1 (2), Fr-1 (3), F_{U}1 (4), F_{U}1 (5)} in the temporary feature list L_tmp_{U} into the features {F_{U}2 (1), F_{U}2 (2), F_{U}2 (3), F_{U}2(4), Ft 2 (5)} in the feature list L_{U}, respectively.

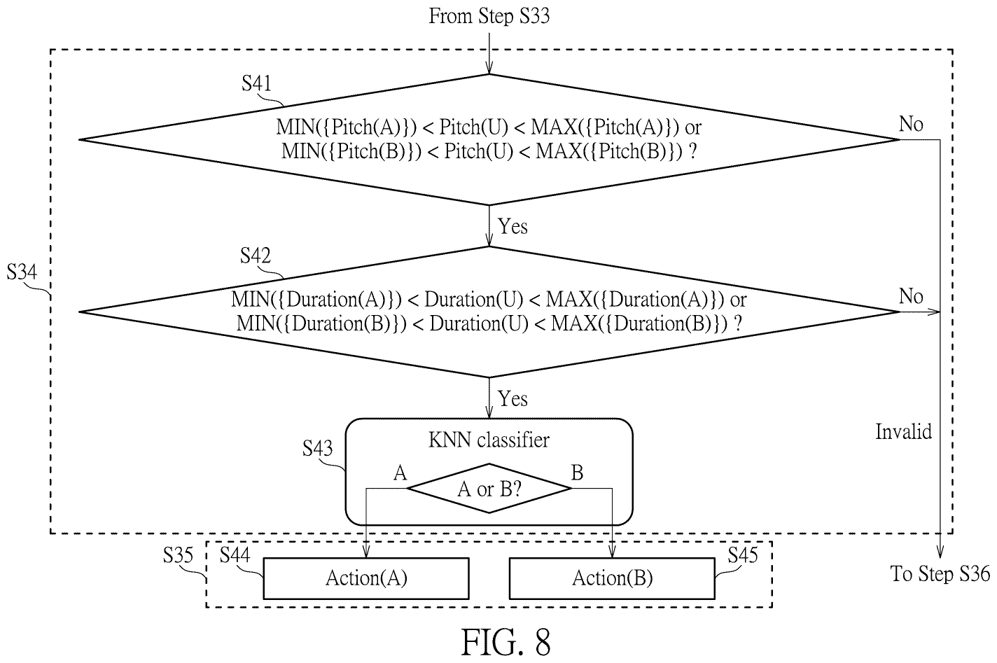

FIG. 8 illustrates a working flow of a speaker identification control scheme of the method according to an embodiment of the present invention. Steps S34 and S35 shown in FIG. 2 may respectively comprise multiple sub-Steps Such as Steps S41 to S43 and Steps S44 and S45, wherein the one or more features may comprise the pitch Pitch( ) and the duration Duration( ).

In Step S41, the processing circuit 110 (or the voice type classification processing module 114) may perform a screening operation on the pitch Pitch(U) in the feature list L_{U} according to the feature-list-based database 142 to determine whether the audio clip Audio_Clipr is invalid, and more particularly, perform the screening operation on the pitch Pitch(U) according to the maximum value MAX ({Pitch(A)}) and the minimum value MIN ({Pitch(A)}) of the pitch {Pitch(A)} in the feature lists {L_{A}} corresponding to the speaker A and the maximum value MAX ({Pitch(B)}) and the minimum value MIN ({Pitch(B)}) of the pitch {Pitch(B)} in the feature lists {L_{B}} corresponding to the speaker B. If MIN ({Pitch(A)})<Pitch(U)<MAX ({Pitch(A)}) or MIN ({Pitch(B)})<Pitch(U)<MAX ({Pitch(B)}), proceed to Step S42; otherwise, in a situation where the audio clip Audio_Clip_{U} (or the speaker U) is determined to be invalid, proceed to Step S36.

In Step S42, the processing circuit 110 (or the voice type classification processing module 114) may perform a screening operation on the duration Duration(U) in the feature list L_{U} according to the feature-list-based database 142 to determine whether the audio clip Audio_Clip_{U} is invalid, and more particularly, perform the screening operation on the duration Duration(U) according to the maximum value MAX ({Duration(A)}) and the minimum value MIN ({Duration(A)}) of the duration {Duration(A)} in the feature lists {L_{A}} corresponding to the speaker A and the maximum value MAX ({Duration(B)}) and the minimum value MIN ({Duration(B)}) of the duration {Duration(B)} in the feature lists {L_{B}} corresponding to the speaker B. If MIN ({Duration(A)})<Duration(U)<MAX ({Duration(A)}) or MIN ({Duration(B)})<Duration(U)<MAX ({Duration(B)}), proceed to Step S43; otherwise, in a situation where the audio clip Audio_Clip_{U} (or the speaker U) is determined to be invalid, proceed to Step S36.

In Step S43, the processing circuit 110 (or the voice type classification processing module 114) may utilize the predetermined classifier such as a k-NN algorithm classifier (or “KNN classifier”) to perform the machine-learning-based classification according to all features in the feature list L_{U} to determine whether the speaker U of the audio clip Audio_Clip_{U} is the speaker A or the speaker B, for selectively proceeding to Step S44 or Step S45. If it is determined that the speaker U is the speaker A, proceed to Step S44; if it is determined that the speaker U is the speaker B, proceed to Step S45.

In Step S44, the processing circuit 110 may execute the action Action(A) corresponding to the speaker A.

In Step S45, the processing circuit 110 may execute the action Action(B) corresponding to the speaker B.

According to some embodiments, one or more steps may be added, deleted, or changed in the working flow shown in FIG. 8.

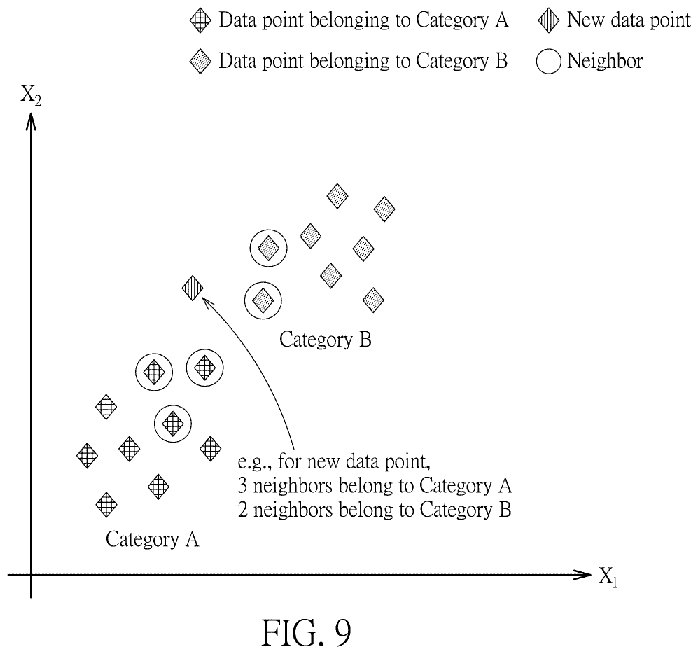

FIG. 9 illustrates data points involved with the k-nearest neighbors (k-NN) algorithm classifier in the speaker identification control scheme according to an embodiment of the present invention. For example, the KNN classifier operating according to the k-NN algorithm may use majority rule to perform classification when dealing with classification issues, and the associated operations may comprise:
(1) determining the k value;
(2) determining the distance between each neighbor and a target data point (e.g., a new data point);
(3) finding the k nearest neighbors to the target data point (e.g., the new data point); and
(4) checking which category/group (e.g., Category A or Category B) among multiple predetermined categories has the largest number of neighbors, in order to classify the target data point (e.g., the new data point) as that category/group (e.g., Category A or Category B) having the largest number of neighbors;
where the multiple predetermined categories such as Categories A and B may correspond to the above-mentioned registered speakers such as the speakers A and B. The dimension (e.g., the axis count of the multiple axes {X₁, X₂, . . . }) of the predetermined space may be equal to the feature-type count (e.g., 5) of the multiple predetermined types of features. For better comprehension, two axes {X₁, X₂} may be taken as examples of the multiple axes {X₁, X₂, . . . } as illustrated in FIG. 9. In addition, the data points belonging to Category A may respectively represent the feature lists {L_{A}}, the data points belonging to Category B may respectively represent the feature lists {L_{B}}, and the new data point may represent the feature list Lt. Additionally, the data point count CNT_Data_point_{A} (e.g., CNT_Data_point_{A}=9) of the data points belonging to Category A may be equal to the feature list count CNT_L_{A} (e.g., CNT_L_{A}=9) of the feature lists {L_{A}}, and the data point count CNT_Data_points (e.g., CNT_Data_pointB=8) of the data points belonging to Category B may be equal to the feature list count CNT_L_{B} (e.g., CNT_L_{B}=8) of the feature lists {L_{B}}. For example, for the new data point, there are three neighbors belonging to Category A and two neighbors belonging to Category B. In this situation, the KNN classifier may classify the new data point as Category A. According to some embodiments, the new data point, the data points belonging to Category A, the data points belonging to Category B, the data point count CNT_Data_point_{A}, the data point count CNT_Data_points, the feature list count CNT_L_{A}, the feature list count CNT_L_{B}, the number of neighbors belonging to Category A, and/or the number of neighbors belonging to Category B may vary. For example, for the new data point, there are two neighbors belonging to Category A and five neighbors belonging to Category B. In this situation, the KNN classifier may classify the new data point as Category B.

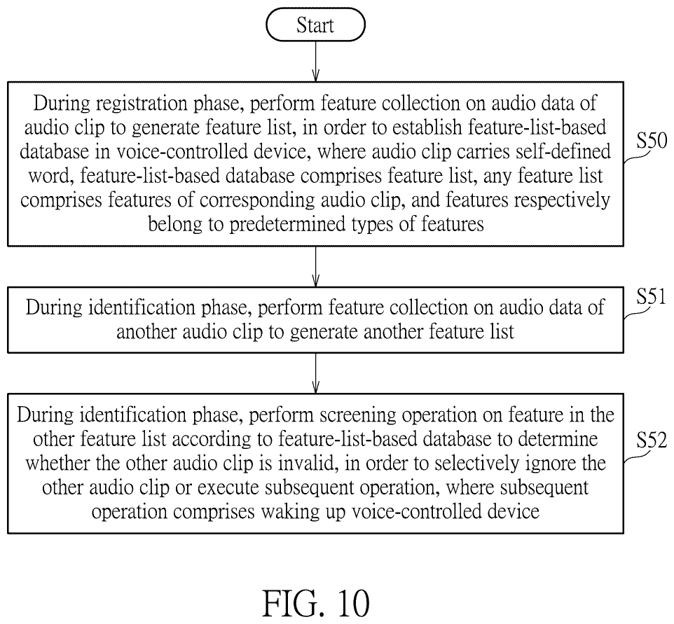

FIG. 10 illustrates a flowchart of the method according to an embodiment of the present invention.

In Step S50, during the registration phase, the processing circuit 110 may perform the feature collection on the audio data Audio_Data (e.g., the audio data {Audio_Data_{A}} and {Audio_Data_{B}}) of at least one audio clip Audio_Clip to generate at least one feature list L (e.g., the feature lists {L_{A}} and {L_{B}}) of the aforementioned at least one audio clip Audio_Clip, in order to establish the feature-list-based database 142 in the voice-controlled device 100, where the aforementioned at least one audio clip Audio_Clip may carry the aforementioned at least one self-defined word W, the feature-list-based database 142 may comprise the aforementioned at least one feature list L, any feature list L among the aforementioned at least one feature list L may comprise multiple features of a corresponding audio clip Audio_Clip among the aforementioned at least one audio clip Audio_Clip, and the multiple features respectively belong to the multiple predetermined types of features.

In Step S51, during the identification phase, the processing circuit 110 may perform the feature collection on the audio data Audio_Data (e.g., the audio data Audio_Data_{U}) of another audio clip Audio_Clip (e.g., the audio clip Audio_Clip_{U}) to generate another feature list L (e.g., the feature list L_{U}) of the other audio clip Audio_Clip.

In Step S52, during the identification phase, the processing circuit 110 may perform at least one screening operation on at least one feature in the other feature list L according to the feature-list-based database 142 to determine whether the other audio clip Audio_Clip is invalid, in order to selectively ignore the other audio clip Audio_Clip or execute at least one subsequent operation, where the aforementioned at least one subsequent operation comprises waking up the voice-controlled device 100.

According to some embodiments, one or more steps may be added, deleted, or changed in the working flow shown in FIG. 10.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing wake-up control on a voice-controlled device with aid of detecting voice feature of self-defined word, the method comprising:
during a registration phase among multiple phases, performing feature collection on audio data of at least one audio clip to generate at least one feature list of the at least one audio clip, in order to establish a feature-list-based database in the voice-controlled device, wherein the at least one audio clip carries at least one self-defined word, the feature-list-based database comprises the at least one feature list, any feature list among the at least one feature list comprises multiple features of a corresponding audio clip among the at least one audio clip, and the multiple features respectively belong to multiple predetermined types of features;
during an identification phase among the multiple phases, performing the feature collection on audio data of another audio clip to generate another feature list of the other audio clip; and
during the identification phase, performing at least one screening operation on at least one feature in the other feature list according to the feature-list-based database to determine whether the other audio clip is invalid, in order to selectively ignore the other audio clip or execute at least one subsequent operation, wherein the at least one subsequent operation comprises waking up the voice-controlled device.

2. The method of claim 1, wherein the at least one audio clip comprises multiple audio clips, and the at least one feature list comprises respective feature lists of the multiple audio clips, wherein the any feature list among the at least one feature list represents a feature list among the respective feature lists of the multiple audio clips, and the corresponding audio clip represents one of the multiple audio clips.

3. The method of claim 1, wherein performing the at least one screening operation on the at least one feature in the other feature list according to the feature-list-based database to determine whether the other audio clip is invalid in order to selectively ignore the other audio clip or execute the at least one subsequent operation further comprises:
if the other audio clip is invalid, ignoring the other audio clip; and
if the other audio clip is not invalid, executing the at least one subsequent operation.

4. The method of claim 1, wherein the at least one audio clip comprises at least one first audio clip of a first user and comprises at least one second audio clip of a second user; and performing the feature collection on the audio data of the at least one audio clip to generate the at least one feature list of the at least one audio clip further comprises:
performing the feature collection on first audio data of the at least one first audio clip to generate at least one first feature list of the at least one first audio clip, wherein each first audio clip among the at least one first audio clip carries a first self-defined word, the feature-list-based database comprises the at least one first feature list, any first feature list among the at least one first feature list comprises multiple first features of a corresponding first audio clip among the at least one first audio clips, and the multiple first features respectively belong to the multiple predetermined types of features; and
performing the feature collection on second audio data of the at least one second audio clip to generate at least one second feature list of the at least one second audio clip, wherein each second audio clip among the at least one second audio clip carries a second self-defined word, the feature-list-based database comprises the at least one second feature list, any second feature list among the at least one second feature list comprises multiple second features of a corresponding second audio clip among the at least one second audio clip, and the multiple second features respectively belong to the multiple predetermined types of features.

5. The method of claim 1, wherein by performing machine learning, a predetermined classifier corresponding to at least one predetermined model is established in the voice-controlled device; the at least one feature in the other feature list is at least one of all features in the other feature list, wherein said all features in the other feature list respectively belong to the multiple predetermined types of features; and the at least one subsequent operation further comprises:
utilizing the predetermined classifier to perform machine-learning-based classification according to said all features in the other feature list to determine whether a speaker of the other audio clip is a first user or a second user, in order to selectively execute at least one first action corresponding to the first user or at least one second action corresponding to the second user.

6. The method of claim 5, wherein a dimension of a predetermined space of the at least one predetermined model is equal to a feature-type count of the multiple predetermined types of features.

7. The method of claim 1, wherein performing the at least one screening operation on the at least one feature in the other feature list according to the feature-list-based database to determine whether the other audio clip is invalid in order to selectively ignore the other audio clip or execute the at least one subsequent operation further comprises:
performing the at least one screening operation on the at least one feature in the other feature list according to the feature-list-based database to determine whether the other audio clip is invalid, in order to selectively ignore the other audio clip or execute the at least one subsequent operation, having no need to link to any cloud database through any network to obtain any speech data for determining which words the at least one self-defined word includes.

8. The method of claim 1, wherein performing the feature collection on the audio data of the at least one audio clip to generate the at least one feature list of the at least one audio clip further comprises:
after recording the corresponding audio clip to obtain corresponding audio data of the corresponding audio clip, analyzing first audio data of a first partial audio clip of the corresponding audio clip to determine an energy threshold and a zero-crossing rate threshold according to multiple first audio frames of the first audio data, for further processing remaining audio data of a remaining partial audio clip of the corresponding audio clip; and
analyzing the remaining audio data of the remaining partial audio clip to calculate respective energy values and zero-crossing rates of multiple second audio frames of the remaining audio data, and determining, according to whether an energy value of any second audio frame among the multiple second audio frames reaches the energy threshold and whether a zero-crossing rate of the any second audio frame reaches the zero-crossing rate threshold, that a voice type of the any second audio frame is one of multiple predetermined voice types, for determining the multiple features of the corresponding audio clip according to respective voice types of the multiple second audio frames.

9. The method of claim 8, wherein performing the feature collection on the audio data of the at least one audio clip to generate the at least one feature list of the at least one audio clip further comprises:
dividing the corresponding audio clip into multiple audio segments according to the respective voice types of the multiple second audio frames, wherein any two adjacent audio frames having a same predetermined voice type among all audio frames of the corresponding audio data belong to a same audio segment, said all audio frames of the corresponding audio data comprise the multiple first audio frames and the multiple second audio frames, and a beginning audio segment among the multiple audio segments comprises at least the multiple first audio frames and corresponds to a first predetermined voice type;
calculating a total time length of at least one main audio segment among the multiple audio segments to be a feature among the multiple features of the corresponding audio clip, wherein the at least one main audio segment comprises one or more audio segments other than the beginning audio segment and any ending audio segment corresponding to the first predetermined voice type among the multiple audio segments; and
calculating at least one segment-level parameter of each audio segment corresponding to a second predetermined voice type among the multiple audio segments to determine at least one parameter of the corresponding audio clip according to the at least one segment-level parameter to be at least one other feature among the multiple features of the corresponding audio clip.

10. A processing circuit, for performing wake-up control on a voice-controlled device with aid of detecting voice feature of self-defined word, the processing circuit comprising:
multiple processing modules, arranged to perform operations of the processing circuit, wherein the multiple processing modules comprise:
a feature list processing module, arranged to perform feature-list-related processing; and
at least one other processing module, arranged to perform feature collection;
wherein:
during a registration phase among multiple phases, the processing circuit performs the feature collection on audio data of at least one audio clip to generate at least one feature list of the at least one audio clip, in order to establish a feature-list-based database in the voice-controlled device, wherein the at least one audio clip carries at least one self-defined word, the feature-list-based database comprises the at least one feature list, any feature list among the at least one feature list comprises multiple features of a corresponding audio clip among the at least one audio clip, and the multiple features respectively belong to multiple predetermined types of features;
during an identification phase among the multiple phases, the processing circuit performs the feature collection on audio data of another audio clip to generate another feature list of the other audio clip; and
during the identification phase, the processing circuit performs at least one screening operation on at least one feature in the other feature list according to the feature-list-based database to determine whether the other audio clip is invalid, in order to selectively ignore the other audio clip or execute at least one subsequent operation, wherein the at least one subsequent operation comprises waking up the voice-controlled device.
